(19) United States
(12) Patent Application Publication
(10) Pub. No.: US 2005/0006188 A1
(43) Pub. Date: Jan. 13, 2005

(54) Disk brake devices

(76) Inventor: Morimasa Takewaki, Anjo-shi (JP)

Correspondence Address: BURNS DOANE SWECKER & MATHIS L L P, POST OFFICE BOX 1404, ALEXANDRIA, VA, 22313-1404, US

(21) Appl. No.: 10/853,751

(22) Filed: May 26, 2004

(30) Foreign Application Priority Data
May 30, 2003 (JP) 2003-154847

(51) Int. Cl. F16D 65/00

(52) U.S. Cl. 188/73.1

(57) ABSTRACT

A disk brake device includes at least one support mechanism disposed between the pad(s) and a mount in order to support the pad(s). The pad(s) can move in the axial direction of the brake disk relative to the mount. The support mechanism(s) counteracts a torque applied to the pad(s) in order to prevent the rotation of the pad(s). The support mechanism(s) is positioned within a region located radially to the outer side of the radially outer edge of the friction member or within a region located radially to the inner side of the radially inner edge of the friction member. Therefore, the direction of the torque applied to the pad(s) may not change even if the friction member wears non-uniformly.

This application claims priority to Japanese patent application serial number 2003-154847, the contents of which are incorporated herein by reference.

### BACKGROUND OF THE INVENTION

1. Field of the Invention

The present invention relates to disk brake devices.

2. Description of the Related Art

Various techniques are known to reduce the squealing sounds produced by disk brake devices. For example, Japanese Laid-Open Patent Publication No. 2000-74107 teaches a disk brake device that is configured to reduce squealing sounds. The disk brake device of this publication includes a pair of pads adapted to be pressed against a brake disk and a mount on which the pads are supported via a support mechanism. The pads are movable in an axial direction of the brake disk.

The support mechanism includes support portions provided on each pad and guide portions provided on the mount. The support portions extend from the right and left edges, in the circumferential direction of the brake disk (in other words, to the front and rear of the vehicle), of each pad in the right and left directions, respectively. The guide portions are configured as recesses formed in the mount in order to receive the respective right and left edges of each pad so that the guide portions slidably support the respective support portions.

A metal plate (metal spring) is interposed between each of the support portions and the corresponding guide portion in order to prevent each pad and the mount from being locked together due to rust. The metal plate is configured so as to bias the pad in a direction that corresponds the rotational direction of the brake disk during normal rotation. Therefore, the pad is prevented from a possible displacement in the rotational direction of the brake disk.

Incidentally, each of the pads includes a friction member that is adapted to contact the surface of the brake disk in order to produce a friction force against the brake disk. In some cases, the pad may not be uniformly worn but instead may be non-uniformly worn. Typically the brake disk has a circular configuration. Therefore, the rotational speed or velocity of a portion of the brake disk surface on the outer peripheral side of the brake disk is greater that the rotational speed or velocity of a portion nearer to the center of the disk, for a given rate of angular rotation. This means that a portion on the outer peripheral side of the friction member has a greater slide contact area with the brake disk per unit time than a portion on the inner peripheral side (on the side toward the center of the brake disk) of the friction member. As a result, the outer peripheral side portion of the pad tends to be more quickly worn than the inner peripheral side portion. Consequently, the friction member is non-uniformly worn.

When such non-uniform wear occurs, the position of the center of pressure applied to the friction member during the pressing operation against the surface of the disk brake may be shifted along the surface of the friction member. For example, the center of pressure may be shifted from the geometrical center of the surface of the friction member toward the inner peripheral edge of the pad (in a direction toward the center of the brake disk). Meanwhile, a torque may be applied to the pad, about an axis parallel to the axis of the brake disk, by the rotating brake disk during the braking operation. The support mechanism may bear against such a torque. However, as the center of pressure is shifted, the direction and the magnitude of the torque may be changed. The support mechanism may not properly support the pad when the direction of the torque has been changed. As a result, in some cases the pad may be allowed to rattle or vibrate and to cause production of an audible squealing sound.

The known brake devices have not been constructed so as to prevent or reduce the rattling or vibration of the pads that may be caused due to the non-uniform wear described above.

### SUMMARY OF THE INVENTION

It is accordingly an object of the present invention to teach improved disk brake devices that can effectively prevent the rattling or vibration of the pads that may be due to non-uniform wear of the pads.

According to one aspect of the present teachings, disk brake devices are taught that include a brake disk and at least one pad having a friction member. For example, a pair of pads may be provided to press against the surfaces of the brake disk from both sides. The friction members of the pads are adapted to be pressed against the brake disk in order to produce a frictional force. The friction member has a radially outer edge and a radially inner edge, with regard to a radial direction of the brake disk. At least one support mechanism is disposed between the pad(s) and a mount in order to support the pad(s), so that the pad(s) can move relative to the mount in an axial direction of the brake disk (perpendicular to the surfaces of the brake disk). For example, a pair of support mechanisms may be provided in order to support the pad(s) from both ends in the circumferential direction about the axis of the brake disk. The support mechanism(s) bears against a torque applied to the pad(s) in order to prevent the rotation of the pad(s). Such a torque is applied to the pad(s) about an axis parallel to the axial direction of the brake disk when the friction member(s) is pressed against the brake disk. The torque may be generated due to the offset between the center of pressure of the friction pads and the loading from the support mechanism(s). The support mechanism(s) is positioned within a region located radially on the outer side of the radially outer edge of the friction member or within a region located radially on the inner side of the radially inner edge of the friction member. Consequently, the direction of the torque applied to the pad(s) may not change regardless of the eventual location of the center of pressure caused by non-uniform wearing of the friction member.

Thus, because the support mechanism(s) is positioned either within a region located radially on the outer side of the radially outer edge of the friction member or within a region located radially on the inner side of the radially inner edge of the friction member, the direction of the torque applied to the pad(s) may not change even after the friction member has been non-uniformly worn. For example, when the friction member has been non-evenly worn, a center of the surface pressure of the friction member(s) may be shifted or offset in the radial direction away from the geometrical center of the surface of the friction member. The center of the surface pressure may be shifted or offset along the surface of the friction member. However, the direction of the torque applied to the pad(s) may not change. Therefore, the support mechanism(s) can reliably stably support the pad(s) without excessive rattling, vibration, or displacement. In other words, the pad(s) may be reliably held in position during the braking operation. Therefore, the squealing sounds generated by the pad(s) can be effectively reduced or minimized.

In another aspect of the present teachings, the support mechanism(s) includes one support mechanism that is positioned to oppose the pad in the predominant rotational direction of the brake disk. Therefore, this support mechanism can effectively bear against the torque generated by the interaction of the pad and the brake disk. Preferably, another support mechanism is provided and positioned to oppose the pad in the rotational direction opposite to the predominant rotational direction of the brake disk.

In another aspect of the present teachings, the support mechanism(s) is positioned within a region located radially on the outer side of a tangential line. The tangential line is drawn tangent to a circle located about the axis of the brake disk. The circle coincides with the circumferential center of the radially outer edge of the friction member. The center of the radially outer edge of the friction member is established with regards to the circumferential direction of the brake disk. The point of tangency is where the circle passes through the circumferential center of the radially outer edge of the friction member. With the location of the support mechanism(s) in this position, the direction of the torque can be reliably maintained in one direction.

In another aspect of the present teachings, the support mechanism(s) is positioned within a region located radially on the inner side of another tangential line. The other tangential line is drawn tangent to another circle positioned about the axis of the brake disk. The other circle coincides with the circumferential center of the radially inner edge of the friction member. The circumferential center of the radially inner edge of the friction member is determined with regard to the circumferential direction of the brake disk. The point of tangency is where the circle passes through the point indicating the circumferential center of the radially inner edge of the friction member. With the location of the support mechanism(s) in this position, the direction of the torque can also be reliably maintained in one direction.

In another aspect of the present teachings, the support mechanism(s) comprises a support portion formed on the at least one pad and a guide portion formed on the mount. The guide portion is slidingly engageable with the support portion.

In another aspect of the present teachings one of the support portion and the guide portion includes a projection. The other of the support portion and the guide portion includes a recess for slidingly engaging the projection.

Preferably, the projection and the recess extend along a line drawn tangent to a circle centered coincident to the rotational axis of the brake disk.

In another aspect of the present teachings, the support portion extends from one end, in the circumferential direction, of the outer peripheral edge of the pad. The recess is formed in the support member. The guide portion includes the projection.

Alternatively, the support portion may extend from one end, in the circumferential direction, of the inner peripheral edge of the pad. The projection may be formed on the support member. The guide portion may include the recess.

In another aspect of the present teachings, the guide portion is positioned radially outward of the brake disk (i.e., outside of and/or beyond the outermost circumferential edge of the brake disk) and extends in the axial direction of the brake disk (perpendicular to the surface of the brake disk) straddling the brake disk. Therefore, the support portion can be supported by the guide portion along a relatively long length in the axial direction of the brake disk. As a result, the support portion can be reliably prevented from being dropped off or unintentionally disconnected from the guide portion. In other words, the pad(s) is prevented from being inadvertently removed from the mount and the mount is able to stably support the pad(s).

### BRIEF DESCRIPTION OF THE DRAWINGS

FIG. 1 is a plan view of a first representative disk brake device; and

FIG. 2 is a sectional view taken along line II-II in FIG. 1; and

FIG. 3 is a front view of the disk brake device as viewed from a direction indicated by arrow III in FIG. 1; and

FIG. 4 is an enlarged perspective view around one support mechanism including a support portion and a guide portion of the disk brake device; and

FIG. 5 is a cross sectional view similar to FIG. 2 but showing a second representative disk brake device.

### DETAILED DESCRIPTION OF THE INVENTION

Each of the additional features and teachings disclosed above and below may be utilized separately or in conjunction with other features and teachings to provide improved disk brake devices. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

### FIRST REPRESENTATIVE EMBODIMENT

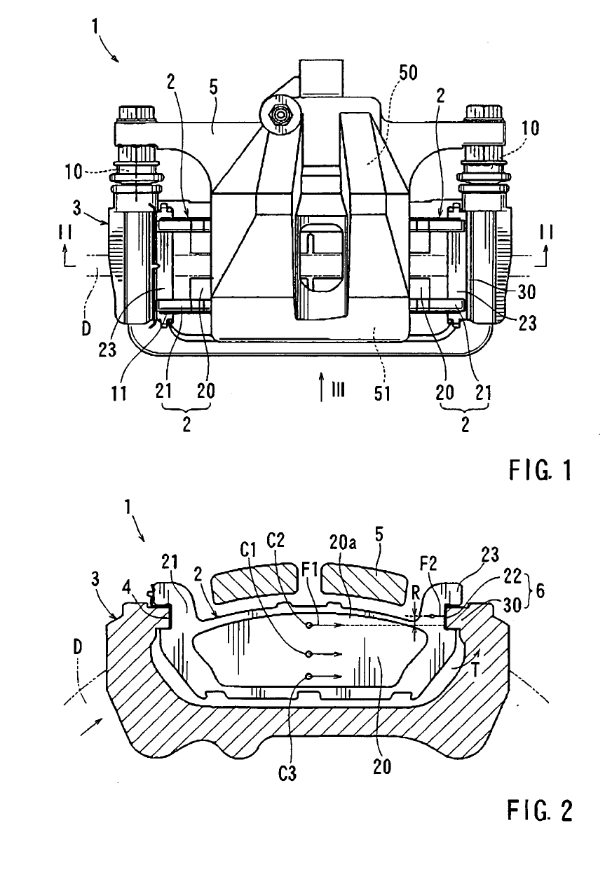

A first representative embodiment will now be described with reference to FIGS. 1 to 4. As shown in FIG. 1, a representative disk brake device 1 includes a pair of pads 2, a caliper 5, and a mount 3. The pads 2 are adapted to be pressed against the surfaces of a brake disk D. A piston 50 is mounted on the caliper 5 in order produce a clamping force for pressing the pads 2 against the surfaces of the brake disk D. The mount 3 movably supports the pads 2 and the caliper 5.

The mount 3 may be fixed to a vehicle (not shown). The caliper 5 is supported on the mount 3 via slide pins 10 so that the caliper 5 is movable relative to the mount 3 in the axial direction of the brake disk D (perpendicular to the surfaces of the brake disk D). The caliper 5 has portions positioned radially outside of the brake disk D and extends over the brake disk D in the axial direction (i.e., straddling the brake disk D). The piston 50 is mounted on the caliper 5, preferably on the inner side with regard to the vehicle (between the brake disk and the vehicle). A claw 51 is mounted on the caliper 5 on the outer side with regard to the vehicle. As the piston 50 extends toward the brake disk D, the pad 2 positioned on the inner side with regard to the vehicle (hereinafter also called “inner pad 2”) may be pressed against a surface of the brake disk D. At the same time, the caliper 5 moves in the direction opposite to the extending direction of the piston 50. Consequently, the claw 51 of the caliper 5 urges the pad 2 positioned on the outer side with regard to the vehicle (hereinafter also called “outer pad 2”) against the other surface of the brake disk D. In this way, the piston 50 and the claw 51 urge the respective pads 2 against the surfaces of the brake disk D in a clamping type of action.

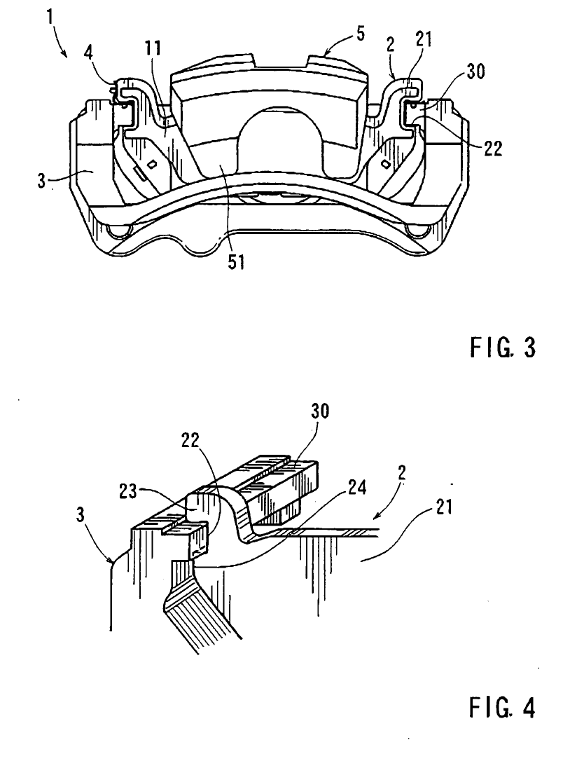

As shown in FIGS. 1 and 2, each of the pads 2 includes a friction member 20 and a back plate 21. The friction member 20 is adapted to be slidingly contacted with a surface of brake disk D. The contact between the friction member 20 and the surface of the brake disk D produce friction force acting against the rotation of the brake disk D. The resulting affect is that the rate of rotational of the disk D may be reduced or stopped. The back plate 21 may be made of metal, such as iron, or may be made of resin. The back plate 21 is adapted to support the friction member 20 from the back side (the side opposite to the contacting side of the friction member 20). As shown in FIG. 3, a shim 11, made of metal plate, is attached to the back side of the back plate 21 (the side of the back plate 21 directly opposing the claw 51 or the piston 50). The shim 11 functions so as to reduce the squealing sounds generated by the pads 2.

As shown in FIG. 2, support mechanisms 6 are provided between the pads 2 and the mount 3. The support mechanisms 6 are provided so that the pads 2 can move in the axial direction of the brake disk D, relative to the mount 3. The support mechanisms 6 include right and left support portions 23 formed integrally with the back plate 21 of each pad 2. The support mechanisms 6 also include right and left guide portions 30 formed integrally with the mount 3. The right and left support portions 23 respectively extend outward in the radial direction of the brake disk D from the right and left ends (with regard to the circumferential direction of the brake disk D) of the outer peripheral portion (with regard to the radial direction of the brake disk D) of the back plate 21. A recess 22 is formed in each of the right and left support portion 23 and has a depth located in the circumferential direction of the brake disk D. The recess 22 preferably has a substantially rectangular cross section and has an opening directly opposing the right or left vertical wall of the mount 3.

As shown in FIG. 2, the right and left guide portions 30 are formed on the right and left vertical walls of the mount 3 and extend toward the right and left support portions 23 of each pad 2, respectively. Each of the right and left guide portions 30 has a substantially rectangular cross section similar to the recess 22 of each support portion 23, so that right and left guide portions 30 engage the corresponding recesses of the right and left support portions 23. Each of the right and left guide portions 30 has a length in a direction parallel to the axial direction of the brake disk D. The right and left support portions 23 can respectively slidably move in a direction parallel to the axial direction of the brake disk D along the right and left guide portions 30.

Because each of the guide portions 30 is opposed to both radially inner and outer surfaces of the recess 22 of the corresponding support portion 23, the support portions 23 are prevented from moving in the radial direction. As a result, the pads 2 are prevented from moving in the radial direction relative to the mount 3 by the guide portions 30. In addition, each of the guide portions 30 is opposed to the bottom of the recess 22 (in the circumferential direction of the brake disk D) of the corresponding support portion 23. Therefore the pads 2 are prevented from moving in a circumferential direction relative to the mount 3. In other words, the pads 2 are constrained from moving along a rotational direction about the rotational axis of the brake disk D.

As shown in FIG. 2, each of the support mechanisms 6 is positioned on the radially outer side of a radially outer peripheral edge 20a of the friction member 20 of each pad 2. Preferably, the center of the support mechanism 6 in the radial direction of the brake disk D (the center of the recess 22 or the guide portion 30 in the radial direction) is set to be radially outward of a tangential line (extending in right and left directions as viewed in FIG. 2) drawn from the center of the outer peripheral edge 20a in the widthwise direction (circumferential direction of the brake disk D).

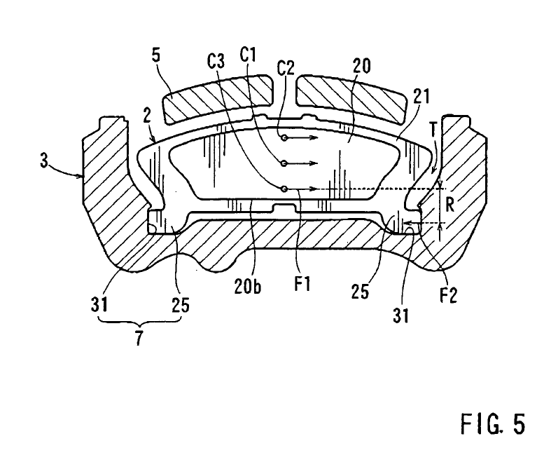

Each of the support mechanisms 6 is also positioned on the radially outer side of the outer peripheral edge of the brake disk D. As described previously, each of the guide portions 30 has a length in a direction parallel to the axial direction of the brake disk D (see FIG. 4). In addition, as shown in FIG. 1, each of the guide portions 30 extends over the brake disk D in a direction parallel to the axial direction of the brake disk D, straddling the brake disk D.

The operation for supporting the pads 2 with the support mechanisms 6 during the braking operation will now be described. When the pads 2 are pressed against the brake disk D, the friction members 20 contact the surfaces of the brake disk D to produce frictional forces. By applying surface pressure to the brake disk D, the rate of rotation of the brake disk D may be reduced. In this occasion as shown in FIG. 2, the brake disk D applies a corresponding force F1 to the friction member 20 of each pad 2 in the rotational direction of the brake disk D. The force F1 may then be transferred to the support mechanisms 6 opposing the pads 2 in the rotational direction of the brake disk D. The support mechanisms 6 apply a reaction force F2 to the friction member 20 in order to bear against or counteract the force F1.

As shown in FIG. 2, the force F1 may be represented by a vector arrow, which starts from a surface pressure center indicated by C1 and extends in a tangential direction with respect to a circumferential line about the rotational axis of the brake disk D. Here, the surface pressure center is the center of the surface pressure applied to the friction member 20 when the friction member 20 is pressed against the disk D. The reaction force F2 may be represented by a vector arrow that is parallel to the vector arrow of the force F1 but extends in the opposite direction to the vector arrow F1. Therefore, a moment is generated by the forces F1 and F2 so as to apply a torque T to each pad 2 about an axis parallel to the rotational axis of the brake disk D. As a result, the support mechanisms 6 opposing the pads 2 in the rotational direction of the brake disk D also counteract against such a torque T in order to prevent the pads 2 from rotating.

During the use of the pads 2, the friction members 20 may be non-uniformly worn in some cases. When this occurs, the surface pressure center may shift from the position indicated by C1 to a position indicated by C2 on the radially outer side of C1. The surface pressure center may also shift to a position indicated by C3 on the radially inner side of C1.

Because the support mechanism 6 is positioned on the radially outer side of the outer peripheral edge 20a of the friction member 20, the support mechanism 6 is always positioned on the radially outer side of the surface pressure center, even if the surface pressure center has been shifted from C1 to C2 or C3. In other words, the starting point of the reaction force F2 is always positioned on the radially outer side of the starting point of the force F1. More specifically, the support mechanism 6 is always positioned on the radially outer side of a tangential line drawn from C2 or C3 with respect to a circumferential line located about the rotational axis of the brake disk D.

According to the representative embodiment, the support mechanism 6 opposing to the pads 2 in the rotational direction of the brake disk D is positioned on the radially outer side of the outer peripheral edge 20a of the friction member 20 of each of the pads 2. When the friction member 20 of each pad 2 is pressed against the surface of the brake disk D, a torque T may be produced to attempt to rotate the pad 2. The torque T is generated due to the moment caused by the force F1, applied by the rotating brake disk D to the friction member 20 in the rotational direction of the brake disk D, and the reaction force F2, applied by the support mechanism 6 in the direction opposite to the direction of the force F1. However, the direction of the torque T may not change even if the starting point (the center of surface pressure) of the force F1 has been changed due to non-uniform wear of the friction member. The direction of the torque T is consistent because the center of the support mechanism 6 is positioned on the radially outer side of the outer peripheral edge 20a of the friction member 20. Thus, the direction of the torque T is always in the opposite direction to the rotational direction of the brake disk D and may not be reversed relative to the rotational direction of the brake disk D. The support mechanisms 6 that oppose the pads 2 in the direction opposite to the rotational direction of the brake disk D may also provide a force against the torque T in a similar manner to the support mechanisms 6 that oppose the pads 2 in the rotational direction of the brake disk D.

Because the direction of the torque T may not change relative to the rotation of the brake disk D during the life and wearing of pads 2, the support mechanisms 6 can reliably and stably support the pads 2 without causing excessive rattling, vibration, or displacement during the braking operation. In other words, the support mechanisms 6 may always bear against the torque T at the same support points. As a result, the squealing sounds generated by the pads 2 can be effectively reduced or minimized.

In addition, as shown in FIG. 1 the guide portions 30 of the support mechanisms 6 extend so as to straddle the brake disk D along the axial direction of the brake disk D. The guide portions 30 are elongated in a direction parallel to the axial direction of the brake disk D. Therefore, the support portions 23 that slide along their respective or corresponding guide portions 30 have a long support length in the axial direction of the brake disk D (as shown in FIG. 4). As a result, the support portions 23 may be reliably supported with a reduced risk of the support portions 23 dropping-off from the guide portions 30. In other words, the pads 2 may be reliably stably supported by the mount 3 with a reduced risk of unintentional removal of the pads 2 from the mount 3.

### SECOND REPRESENTATIVE EMBODIMENT

A second representative embodiment will now be described with reference to FIG. 5. The second representative embodiment is essentially the same as the first representative embodiment with the exception of the configuration of the support mechanisms. Instead of the support mechanism 6, the second representative embodiment has alternative support mechanisms 7.

Similar to the support mechanisms 6 of the first representative embodiment, the support mechanisms 7 include right and left support portions 25 formed integrally with the back plate 21 of each pad 2, and right and left guide portions 31 formed integrally with the mount 3. The right and left support portions 25 respectively extend inward in the radial direction of the brake disk D (toward the center of the brake disk D) from right and left ends (with regard to the circumferential direction of the brake disk D) of the inner peripheral portion (with regard to the radial direction of the brake disk D) of the back plate 21. In addition, the right and left support portions 25 are respectively extended rightward and leftward in the circumferential direction of the brake disk D.

The right and left guide portions 31 are configured as recesses formed in the mount 3 and has openings on the side opposing to the pads 2. The right and left support portions 25 have a substantially rectangular cross section. The right and left guide portions 31 also have a substantially rectangular cross section to conform to the cross section of the right and left support portions 25, so that the right and left support portions 25 engage the right and left guide portions 31, respectively.

Each support mechanism 7 (comprising the support portion 25 and the guide portion 31) is positioned on the radially inner side (closer to the center of brake disk D) with regard to the radial direction of the brake disk D of an inner peripheral edge 20b of the friction member 20 of each pad 2. More specifically, the center of each support mechanism 7, i.e., the center of the support portion 25 or the guide portion 31 in the radial direction of the brake disk D is set to be radially inward of a tangential line (extending in right and left directions as viewed in FIG. 5) drawn from the center of the inner peripheral edge 20b in the widthwise direction (circumferential direction of the brake disk D).

Also with this second representative embodiment, a torque T may be produced so as to rotate the pad 2 due to a moment applied to the pad 2. The moment is caused by a force F1, applied to the friction member 20 in the rotational direction of the brake disk D by the rotating brake disk D, and a reaction force F2, applied by the support mechanism 7 in the opposite direction to the direction of the force F1. Therefore, the support mechanisms 7 bear against such a torque T in order to prevent rotation of the pads 2. In other words, the rotation of the pads 2 is counteracted by an opposing moment generated by the support mechanisms 7.

Because the support mechanisms 7 opposing the pads 2 in the rotational direction of the brake disk D are positioned on the radially inner side of the inner peripheral edge 20b of the friction member 20 of each pad 2, the direction of the torque T may not change in the second representative embodiment even if the center of surface pressure applied to the pad 2 has been changed due to non-uniform wear. Thus, the direction of the torque T may be always the same and may not be reversed relative to the rotation of the brake disk D, so that the pads 2 can be reliably and stably supported. Therefore, the squealing sounds generated by the pads 2 can be effectively reduced or minimized in the second representative embodiment.

### OTHER POSSIBLE EMBODIMENTS

The present invention may not be limited to the above representative embodiments but may be modified in various ways, including but not limited to the following:

(1) Although the support portions 23 of each pad 2 are configured to have recesses 22 and the guide portions 30 of the mount 3 is configured as projections in the first representative embodiment, the support portions 23 may be configured as projections and the guide portions 30 may be configured to have recesses for engaging with the projections.

(2) Similarly, although the support portions 25 of each pad 2 are configured as projections and the guide portions 31 of the mount 3 are configured to have recesses in the second representative embodiment, the support portions 25 may be configured to have recesses and the guide portions 31 may be configured to have projections to for engaging with the recesses.

(3) Although the support mechanisms 6 and 7 of the first and second representative embodiments are positioned adjacent to the right and left ends of the pads 2 in the circumferential direction of the brake disk D, the positions of the support mechanisms 6 and 7 may not be limited to these positions but may be set to positions on the side of the center of the pads 2 with regard to the circumferential direction of the brake disk D.

1. A disk brake device comprising:
a brake disk comprising;
at least one brake disk surface; and
at least one pad comprising;
a friction member arranged and constructed to be pressed against the brake disk surface, comprising;
a radially outer edge with respect to a radial direction of the brake disk; and
a radially inner edge with respect to the radial direction of the brake disk; and
a mount; and
at least one support mechanism, and
wherein the at least one support mechanism establishes a sliding interface between the pad and the mount, and
wherein the at least one support mechanism is arranged and constructed to allow the at least one pad to move in an axial direction of the brake disk relative to the mount; and
wherein the at least one support mechanism is arranged and constructed to counteract a torque applied to the at least one pad in order to prevent rotation of the at least one pad, and
wherein the at least one support mechanism is positioned within a region located radially outward of the radially outer edge of the friction member.

2. The disk brake device as in claim 1, wherein the at least one support mechanism is positioned to oppose the at least one pad in a predominant rotational direction of the brake disk.

3. The disk brake device as in claim 2, wherein another support mechanism is positioned to oppose to the at least one pad in a rotational direction opposite to the predominant rotational direction of the brake disk.

4. The disk brake device as in claim 1, wherein the at least one support mechanism is positioned within a region located radially to the outer side of a line that is established tangent to a circle, and
wherein a center of the circle is coincident with a rotational axis of the brake disk, and
wherein the circle passes through a point established at a center of the radially outer edge of the friction member, and
wherein the center of the radially outer edge of the friction member is determined with respect to a circumferential direction of the brake disk, and
wherein a point of tangency of the line is established at the point where the circle passes through the center of the radially outer edge of the friction member.

5. The disk brake device as in claim 1, wherein the at least one support mechanism comprises;
a support portion formed on the at least one pad, and
a guide portion formed on the mount, and
wherein the support portion is slidingly engageable with the guide portion.

6. The disk brake device as in claim 5, wherein one of the support portion and the guide portion includes a projection, and
wherein the other of the support portion and the guide portion includes a recess for engaging the projection.

7. The disk brake device as in claim 6, wherein the projection and the recess extend along a line tangent to a circle,
wherein a center of the circle is coincident with a rotational axis of the brake disk.

8. The disk brake device as in claim 6, wherein the support portion extends from one end of an outer peripheral edge of the pad, and
wherein the outer peripheral edge of the pad is determined with respect to the radial direction of the brake disk, and
wherein the one end of the outer peripheral edge of the pad is determined with regard to the circumferential direction of the brake disk, and
wherein the support portion includes the recess, and
wherein the guide portion includes the projection.

9. The disk brake device as in claim 6, wherein the brake disk comprises;
a first brake disk surface, and
a second brake disk surface, and
a circumferential edge,
wherein the guide portion is positioned radially outward of the circumferential edge of the brake disk, and
wherein the guide portion extends in the axial direction of the brake disk, and
wherein the guide portion straddles the first brake disk surface and the second brake disk surface.

10. A disk brake device comprising:
a brake disk comprising;
at least one brake disk surface; and
at least one pad comprising;
a friction member arranged and constructed to be pressed against the brake disk surface, comprising;
a radially outer edge with respect to a radial direction of the brake disk; and
a radially inner edge with respect to the radial direction of the brake disk; and
a mount; and
at least one support mechanism, and
wherein the at least one support mechanism establishes a sliding interface between the pad and the mount, and
wherein the at least one support mechanism is arranged and constructed to allow the at least one pad to move in an axial direction of the brake disk relative to the mount; and
wherein the at least one support mechanism is arranged and constructed to counteract a torque applied to the at least one pad in order to prevent rotation of the at least one pad, and
at least one support mechanism is positioned within a region located inward of the radially inner edge of the friction member.

11. The disk brake device as in claim 10, wherein the at least one support mechanism is positioned to oppose the at least one pad in a predominant rotational direction of the brake disk.

12. The disk brake device as in claim 11, wherein another support mechanism is positioned to oppose the at least one pad in a rotational direction opposite to the predominant rotational direction of the brake disk.

13. The disk brake device as in claim 10, wherein the at least one support mechanism comprises;
a support portion formed on the at least one pad, and
a guide portion formed on the mount, and
wherein the support portion is slidingly engageable with the guide portion.

14. The disk brake device as in claim 13, wherein one of the support portion and the guide portion includes a projection, and
wherein the other of the support portion and the guide portion includes a recess for engaging the projection.

15. The disk brake device as in claim 10, wherein the at least one support mechanism is positioned within a region located radially to the inner side of a line that is established tangent to a circle, and
wherein a center of the circle is coincident with a rotational axis of the brake disk, and
wherein the circle passes through a point established at a center of the radially inner edge of the friction member, and
wherein the center of the radially inner edge of the friction member is determined with respect to a circumferential direction of the brake disk, and
wherein a point of tangency of the line is established at the point where the circle passes through the center of the radially inner edge of the friction member.

16. The disk brake device as in claim 14, wherein the support portion extends from one end of an inner peripheral edge of the pad, and
wherein the inner peripheral edge of the pad is determined with respect to the radial direction of the brake disk, and
wherein the one end of the inner peripheral edge of the pad is determined with regard to the circumferential direction of the brake disk, and
wherein the support portion includes the projection, and
wherein the guide portion includes the recess.

17. A disk brake device comprising:
a brake disk comprising;
an inner brake disk surface, and
an outer brake disk surface, and
an circumferential edge, and
two pads each comprising;
a friction member arranged and constructed to be pressed against a brake disk surface, comprising;
a radially outer edge with respect to a radial direction of the brake disk; and
a radially inner edge with respect to the radial direction of the brake disk; and
a mount; and
two support mechanisms for each pad, wherein each support mechanism comprises;
a support portion formed on the pad, and
a guide portion formed on the mount, and
wherein the support portion is slidingly engageable with the guide portion, and
wherein the support mechanisms establishes a sliding interface between the pad and the mount, and
wherein the support mechanisms are arranged and constructed to allow each pad to move in an axial direction of the brake disk relative to the mount; and
wherein the support mechanisms are arranged and constructed to constrain each pad in a plane of motion parallel to the surface of the brake disk, and
wherein the support mechanisms is positioned within a region located radially outward of the radially outer edge of the friction member, and
wherein the guide portion is positioned radially outward of the circumferential edge of the brake disk, and
wherein the guide portion extends in the axial direction of the brake disk, and
wherein the guide portion straddles the inner brake disk surface and the outer brake disk surface.
